(19) United States
(12) Patent Application Publication
(10) Pub. No.: US 2022/0237195 A1
(43) Pub. Date: Jul. 28, 2022

(54) Full Fidelity Semantic Aggregation Maps of Linguistic Datasets

(71) Applicants: Anthony Brian Mallgren, Bronx, NY (US); Deidre Rae Mallgren, Spokane Valley, WA (US)

(72) Inventors: Anthony Brian Mallgren, Bronx, NY (US); Deidre Rae Mallgren, Spokane Valley, WA (US)

(21) Appl. No.: 17/214,859

(22) Filed: Mar. 27, 2021

Related U.S. Application Data
(60) Provisional application No. 63/140,828, filed on Jan. 23, 2021.

(51) Int. Cl. G06F 16/2455; G06F 16/248; G06F 40/30

(52) U.S. Cl. CPC G06F 16/24558; G06F 40/30; G06F 16/248

(57) ABSTRACT

Allows querying a linguistic dataset and presenting partial view of full fidelity results in an aggregated and navigable format.

### BENEFIT CLAIM

This application is a continuation of application No. 63/140,828, flied 23 Jan. 2021, a provisional application which is claimed as an earlier filing date.

### FIELD OF THE INVENTION

The invention contributes to and serves language and statistics. More specifically, it covers techniques in analyzing and navigating linguistic data.

### BACKGROUND OF THE INVENTION

Prior art proposes to abandon the whole of the content in returning a set of single documents, many times too numerous to review in full. The manner of presentation leaves many documents untapped. Using full fidelity semantic aggregation maps of linguistic datasets, one may interact with many documents at once (a segment a consumer may be reading may occur multiple times across multiple documents). In the right scenarios, this may improve a consumer's experience.

### BRIEF SUMMARY OF THE INVENTION

Phrasing commonalities and linguistic attribution (e.g., markup, parts of speech, chunking, synonyms, pronunciation keys) are used to produce semantic aggregation maps. These result sets add depth and understanding in interacting with linguistic datasets.

### BRIEF DESCRIPTION OF THE DRAWING

FIG. 1—Shows how a simple query may function, with results that display the count of occurrence.

FIG. 2—Demonstrates how navigation may occur.

### DETAILED DESCRIPTION OF THE INVENTION

Linguistic data may be collected, targeted, and compared with a query term. Data, forward (word or segment of words after query match), backward (word or segment of words before query match), or both, may be collected, aggregated, and presented to the user for analysis and/or navigation.

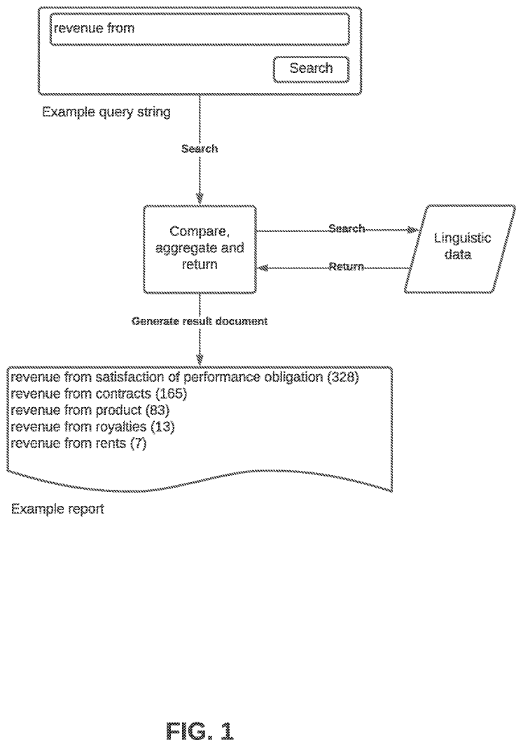

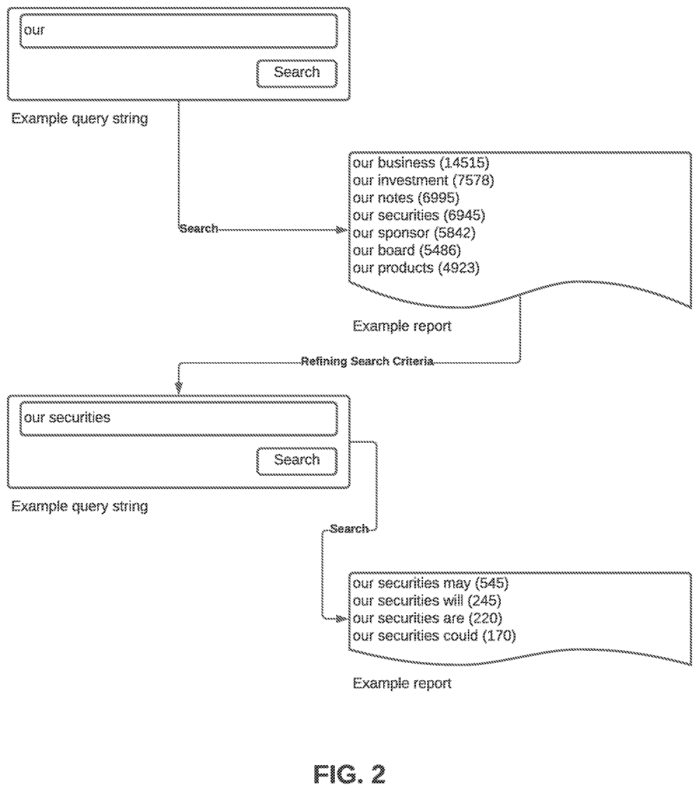

FIG. 1 shows a simple user interface used to initiate the process. Passing the query string, it is compared with linguistic data, forward data is collected when a match occurs, then aggregated. The aggregates are then presented to the user. Once the aggregates are displayed, the user can navigate the data as shown in FIG. 2, including modifying the search box, click through or other mechanisms.

Additional linguistic attributes, as at least partially listed above, may be used to improve the quality of the queries, interaction, and results.

Data in this format may be useful to individuals or organizations looking to maintain a better understanding of prolific individuals, crowds, or companies.

1. A computer implemented method of processing a query in comparison to a linguistic dataset, building a partial view of a full fidelity map comprised of pre- and/or post-query term match aggregations, then returning and presenting the results as a primary dataset.

2. Integrating method 1 by reference, a computer implemented method of one or more load processing sharing schemes, allowing redundancy and scaling.

3. Integrating method 1 by reference, a computer implemented method of a timing mechanism to launch a process which may be used to build reports without being initiated by human interaction.

4. Integrating method 1 by reference, a computer implemented method of excluding or including results could be used for tailoring result sets, current and future.

5. Integrating method 3 and 4 by reference, a computer implemented method, using a state server to keep historical record of results.

6. Integrating method 5 by reference, a computer implemented method for allowing one to create conditions that are stored.

7. Integrating method 6 by reference, a computer implemented method for reading conditions in comparing one or more result sets to determine if an action should be executed.
